(19) United States
(12) Patent Application Publication
(10) Pub. No.: US 2024/0169216 A1
(43) Pub. Date: May 23, 2024

(54) PREDICTING RECORD TOPIC USING TRANSITIVE RELATIONS

(71) Applicant: Oracle Financial Services Software Limited, Mumbai (IN)

(72) Inventors: Utkarsh Hemant Kumar Sharma, Mumbai (IN); Rahul Yadav, Alwar (IN); Veresh Jain, Bangalore (IN); Sharoon Saxena, Bhopal (IN)

(73) Assignee: Oracle Financial Services Software Limited, Mumbai (IN)

(21) Appl. No.: 18/056,456

(22) Filed: Nov. 17, 2022

(51) Int. Cl. G06N 5/02

(52) U.S. Cl. CPC G06N 5/022

(57) ABSTRACT

A method includes generating dataset using topics associated with historical records, the dataset including pairs of data that are formed based on the topics, each of the pairs of data including an antecedent topic associated with a historical record corresponding to a preceding event and a consequent topic associated with a historical record corresponding to an event that occurred after the preceding event, the antecedent topic and the consequent topic forming a transitive relation for each of the pairs of data; inputting, into ML model, the pairs of data and input topic associated with a record of a user; generating, by the ML model, a prediction of a next record topic for a next record corresponding to the user, based on the consequent topic included in each of the pairs of data that include the antecedent topic corresponding to the input topic; and outputting the prediction.

### FIELD

The present disclosure relates generally to artificial intelligence (AI), and, more particularly, to predicting a record topic by mining transitive relations using machine learning (ML).

### BACKGROUND

Machine learning is an area of artificial intelligence where computers have the capability to learn without being explicitly programmed. There are different types of ML techniques including supervised learning techniques, unsupervised learning techniques, and others. In a supervised learning technique, an ML model is created and trained using training data, where the training data includes multiple training examples, each training example including an input and a known output corresponding to the input. An input can include one or multiple features. As a part of the training, the model being trained learns a function that maps the inputs in the training data to their corresponding known outputs. After a model has been adequately trained using the training data, it can then be used for making output predictions for new inputs where the outputs are not known. This is often referred to as the inferencing phase.

In an unsupervised learning technique, an ML model is created and provided with unlabeled data, and is tasked to analyze and find patterns in the unlabeled data. The examples of unsupervised learning technique are dimension reduction and clustering.

Artificial intelligence and machine learning have many applications. For example, using artificial intelligence models or algorithms, content records can be categorized into categories or topics, where each record may correspond to a topic.

In recent years, systems and methods have been developed that could predict a topic of the next record, e.g., a category of a next transaction of a user, using artificial intelligence. However, some records, such as transactions, contain little meaningful contextual information that can be extracted and used by ML algorithms, e.g., ML models. For example, the records might have highly variable context, inconsistent terminology, and inconsistent formats. Further, the content data in the records can be abbreviated or obfuscated. Additionally, the specific records, e.g., transactions, are available in fewer amounts since most of the transaction data is private and confidential.

In order for the model to predict a topic of the next record accurately and reliably, a dataset containing a large amount of various data is needed to be provided to the model. The data in the dataset also has to be diverse covering various situations and different types of topics associated with the records. The availability of such data is presently very limited due at least partially to the reasons discussed above. Additionally, the data is inconsistent and does not include reliable information.

As a result, data that is typically available for AI to predict the topic of the next record is limited and low quality, leading to degraded performance (e.g., accuracy) of the ML algorithms.

### SUMMARY

Techniques are provided for accurately predicting a next record topic using ML algorithms based on transitive relations among the previous records.

Various embodiments are described herein, including methods, systems, non-transitory computer-readable storage media storing programs, code, or instructions executable by one or more processors, and the like.

In various embodiments, a computer-implemented method includes: generating a dataset using a plurality of topics associated with a plurality of historical records, respectively, the dataset including pairs of data that are formed based on the plurality of topics, each of the pairs of data including an antecedent topic associated with a historical record corresponding to a preceding event and a consequent topic associated with a historical record corresponding to an event that occurred after the preceding event, the antecedent topic and the consequent topic forming a transitive relation for each of the pairs of data, where the plurality of historical records are associated with a plurality of user identifiers of different users; inputting, into a machine learning (ML) model, the pairs of data and an input topic, among the plurality of topics, which is associated with a record of a user, the record of the user corresponding to a first event and being associated with a user identifier for the user; generating, by the ML model, one or more predictions of one or more next record topics for a next record corresponding to the user identifier, based on consequent topics included in the pairs of data that include an antecedent topic corresponding to the input topic, where the next record corresponds to a second event; and outputting the one or more predictions. The antecedent topic and the consequent topic are included in the plurality of topics.

In some embodiments, the generating the dataset further includes: obtaining historical reports for the plurality of user identifiers, respectively, each respective historical report including topics associated with a respective historical record for one of the plurality of user identifiers, the topics being arranged in a sequence based on a timeline, where the topics are included in the plurality of topics, and forming each of the pairs of data to include a first topic of the topics that is associated with a first time point on the timeline and a second topic of the topics that is associated with a second time point on the timeline that is later in time than the first time point, as the antecedent topic and the consequent topic, respectively.

In some embodiments, the generating the dataset further includes: calculating a support value for each of the pairs of data, based on a total number of the plurality of historical records and a first number of the pairs of data that include a same first topic and a same second topic; comparing the support value to a first predetermined threshold value; and performing first filtering on the pairs of data by removing the pairs of data whose support value is smaller than or equal to the first predetermined threshold value, and outputting the pairs of data whose support values are greater than the first predetermined threshold value, where the same first topic corresponds to the antecedent topic or the consequent topic, and the same second topic corresponds to the antecedent topic or the consequent topic.

In some embodiments, the generating the dataset further includes: calculating a confidence value for each of the pairs of data remaining subsequent to the first filtering, based on a second number of the pairs of data that include a same antecedent topic followed by a same consequent topic, and a third number of historical records among the plurality of historical records that include the same antecedent topic; comparing the confidence value to a second predetermined threshold value; performing second filtering on the pairs of data remaining subsequent to the first filtering, by removing the pairs of data whose confidence value is smaller than or equal to the second predetermined threshold value, and outputting filtered pairs of data having the confidence value greater than the second predetermined threshold value; and calculating a lift value for each of the filtered pairs of data based on the confidence value associated with each of the filtered pairs of data and a fourth number of historical records among the plurality of historical records that include the same consequent topic.

In some embodiments, the inputting the filtered pairs of data further includes inputting, into the ML model, the confidence value and the lift value that correspond to each of the filtered pairs of data, and the generating the one or more predictions further includes: generating the one or more predictions based on the input topic and one or more consequent topics included in one or more pairs of data among the filtered pairs of data that include the antecedent topic corresponding to the input topic.

In some embodiments, the one or more pairs of data are included in a plurality of pairs of data, and the generating the one or more predictions further includes: ordering the plurality of pairs of data in an order of decreasing confidence values, identifying, as a first result group, first pairs of data among the plurality of pairs of data that have greatest confidence values, where a number of the first pairs of data is defined to be greater than 1 and smaller than a predetermined first number, identifying, as a second result group, second pairs of data from the first result group that have greatest lift values, where a number of the second pairs of data is defined to be not smaller than 1 and smaller than the predetermined first number, and generating the one or more predictions based on the second pairs of data.

In some embodiments, the computer-implemented method further includes, based on the one or more predictions of the one or more next record topics, outputting a message for the user.

In some embodiments, the user is not one of the different users or is one of the different users.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments in accordance with the present disclosure will be described with reference to the drawings, in which:

FIG. 1A depicts a simplified block diagram of a record topic prediction system in accordance with various embodiments.

FIG. 1B depicts a simplified block diagram of a record topic prediction system in accordance with various embodiments.

FIG. 1C is a simplified block diagram of a record topic prediction system in a cloud service provider (CSP) infrastructure according to an embodiment.

FIG. 1D is a simplified block diagram of a record topic prediction system in a distributed computing environment according to an embodiment.

FIG. 1E depicts a simplified block diagram of a record topic prediction system in accordance with various embodiments.

FIG. 2A depicts an example of a transaction report, in accordance with various embodiments.

FIG. 2B depicts an example of a historical report according to various embodiments.

FIG. 2C depicts an example of a result of processing performed according to various embodiments.

FIG. 3A depicts a simplified flowchart illustrating processing in accordance with various embodiments.

FIG. 3B depicts a simplified flowchart illustrating processing in accordance with various embodiments.

FIG. 3C depicts a simplified flowchart illustrating processing in accordance with various embodiments.

FIG. 4 depicts a simplified diagram of a distributed system for implementing various embodiments.

FIG. 5 is a simplified block diagram of one or more components of a system environment by which services provided by one or more components of an embodiment system may be offered as cloud services, in accordance with various embodiments.

FIG. 6 illustrates an example computer system that may be used to implement various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Techniques are provided for accurately predicting a next record topic using unsupervised ML techniques based on transitive relations among the previous records. Techniques described herein arrange topics of historical records in pairs of data, so that each pair of data includes an antecedent topic corresponding to a preceding event and a consequent topic corresponding to a subsequent event, and use the pairs of data to estimate a next topic of a next record of a user based on a current topic of a current record of the user, by matching the current topic to the antecedent topic in the pairs of data and generating one or more predictions for one or more next record topics of the next record based on the consequent topic included in those pairs of data where the matching antecedent topic is identified. Various embodiments are described herein, including methods, systems, non-transitory computer-readable storage media storing programs, code, or instructions executable by one or more processors, and the like.

Records, e.g., transaction records, that describe corresponding topics are present in various forms, e.g., records of a personal bank account, records of a corporate account, etc. Each record may correspond to a topic or a category.

Topic categorization is a process of classifying a record topic, e.g., a transaction category. Topic categorization is performed to understand the context and purpose of a specific event corresponding to a record.

Herein, a transaction may be referred to as an event, a transaction record may be referred to as a record, and a transaction category may be referred to as a record topic.

Generally, the records are one of the most vital elements of an entity, e.g., a bank, a merchant, etc. However, from the ML perspective, transaction data is not very rich source of information for the ML algorithms. In the current practice, most future promotions related to the current records corresponding to events are based on a limited understanding of data. For example, at the start of every month, regardless of whether the user is interested in a loan, the user may receive a message that they are eligible, e.g., for a loan.

Presently, the related art uses few ML approaches with respect to the next record topic prediction. One approach uses binary classification that solves a task of whether the customer will make a transaction (0) or will not make a transaction (1). However, this approach does not consider the type and order of transactions. Further, this approach requires information-rich manually labeled datasets that are generally not available in real-world cashflow transaction use case.

Another approach uses sequential models to predict the sequence element of the sequence. However, this approach cannot handle well inconsistencies in timestamps (e.g., lack of data for a period of time when the data is expected), and requires larger data to be trained. Further, this approach suffers from the cold start problem that occurs when unknown data is input into the model.

Yet another approach uses hidden Markov models. This approach works well for the next state estimation, but requires defining of the states and prior probabilities beforehand, e.g., a great number of rules needs to be defined, which is turn leads to an extensive human involvement for writing the rules. Further, the defining of the states requires a large amount of data that is not available, as discussed above. Additionally, similarly to the sequential model, this approach cannot handle well a change in timestamps.

In the time-based approaches, such as the sequential model and Markov models, the records are examined as a time-based entity and then it is determined how the record topics vary depending on the time of week/month/year. For example, in the time-based entity, the records are examined based on what happens in the first week and the second week. Then, a prediction is made that this event will happen in the third week. The problem with this approach is that the different people are making different number of transactions per time period. In some instances, one or more of the weeks may have no records. The currently available machine learning models cannot provide reliable processing results for such situations because the input is null values.

Further, in the current methods, the prediction of the record topics using machine learning is based on every account. This requires the generation of a separate ML algorithm (or ML model) to predict, e.g., forecast, a record topic of the next event for each individual user, e.g., an account. Additionally, as mentioned above, the transaction data is relatively sparse and isolating the account-specific data does not permit using large data amount to provide more accurate and diverse information to the model. This impedes an ability of a data scientist to train the model accurately and efficiently.

Additionally, each and every person or each and every corporate account having their own individual machine learning model is cumbersome and difficult to manage due to the unavoidable lack of sufficient data at individual account level. Additionally, the individual model's performance differs among the models, again due to the lack of individual account's data and uneven amounts of data available for each model.

The insufficiency and unreliability of data presents big hurdles for machine learning.

Another drawback of the current methods is that the currently-used ML algorithms typically perform point prediction, thereby predicting only one future record topic. However, in real life, there can be multiple potential sequences of the events that could take place.

The present disclosure describes solutions that are not plagued by the above-mentioned problems. Techniques are described for accurately predicting a next record topic using unsupervised ML techniques based on transitive relations among the previous records. Techniques described herein arrange topics of historical records in pairs of data, so that each pair of data includes an antecedent topic corresponding to a preceding event and a consequent topic corresponding to a subsequent event, and use the pairs of data to estimate a next topic of a next record of a user based on a current topic of a current record of the user, by matching the current topic to the antecedent topic in the pairs of data and generating one or more predictions for one or more next record topics of the next record based on the consequent topic included in those pairs of data where the matching antecedent topic is identified.

In embodiments, a single model can process all the accounts with the similar or the same attributes or context at once and predict the next categories for these accounts. Further, the described techniques are adaptable to varying data.

In certain implementations, a single ML model is operated across all accounts where the transitive relations are mined across all accounts. This allows to improve the ML model efficiency and performance by improving accuracy with the collection of more data across accounts. Also, this mitigates the cold start problem that exists in the related art methods.

The techniques described herein overcome the problem of the lack of transaction data by using one model to process the data collected from a great number of accounts of different users or customers and make a prediction for any given user or given customer based on all of the collected data.

In certain implementations, a single model can be used across all retail accounts, corporate accounts, personal accounts, etc., e.g., accounts associated with the same or similar attributes or context.

The novel approach mitigates the issue of the model instability and lack of data that may be associated with some of the accounts.

The embodiments implement an extensive data-driven approach in which a user is targeted based on their transaction behavior rather than timing of the month or day of the week. E.g., the techniques described herein are time-independent, and use an extensive data-driven method to predict the next record topic. This leads to better-targeted marketing and effective advertisements.

In an embodiment, a computer-implemented method includes: generating a dataset using a plurality of topics associated with a plurality of historical records, respectively, the dataset including pairs of data that are formed based on the plurality of topics, each of the pairs of data including an antecedent topic associated with a historical record corresponding to a preceding event and a consequent topic associated with a historical record corresponding to an event that occurred after the preceding event, the antecedent topic and the consequent topic forming a transitive relation for each of the pairs of data, where the plurality of historical records are associated with a plurality of user identifiers of different users; inputting, into a machine learning (ML) model, the pairs of data and an input topic, among the plurality of topics, which is associated with a record of a user, the record of the user corresponding to a first event and being associated with a user identifier for the user; generating, by the ML model, one or more predictions of one or more next record topics for a next record corresponding to the user identifier, based on the consequent topic included in each of the pairs of data that include the antecedent topic corresponding to the input topic, where the next record corresponds to a second event; and outputting the prediction. The user may be one of the different users or the user might not be one of the different users.

In certain implementations, a single ML model is operated across all accounts where the transitive relations are mined across all accounts. The techniques described herein overcome the problem of the lack of transaction data by using one model to process the data collected from a great number of accounts of different users and make a prediction for any given user based on all of the collected data. This allows to improve the ML model efficiency and performance by improving accuracy with the collection of more data across accounts. Also, this mitigates the cold start problem that exists in the related art methods. Therefore, the described techniques improve the technical field of software arts.

The novel approach mitigates the issue of the model instability and lack of data that may be associated with particular accounts by using data mining across the multiple different accounts, where a prediction for a given account may be made based on an entire data collection, thereby the problem that the individual models do not perform with uniform measure of accuracy for individual accounts may be eliminated because all accounts use a large collection of data of a superior quality. The above also is an improvement the technical field of software arts. Further, using a single model for all accounts as compared to an individual model for each individual account improves functioning of the computer, by preserving computational resources since only one model is created and used.

### Record Topic Prediction System and Techniques Thereof

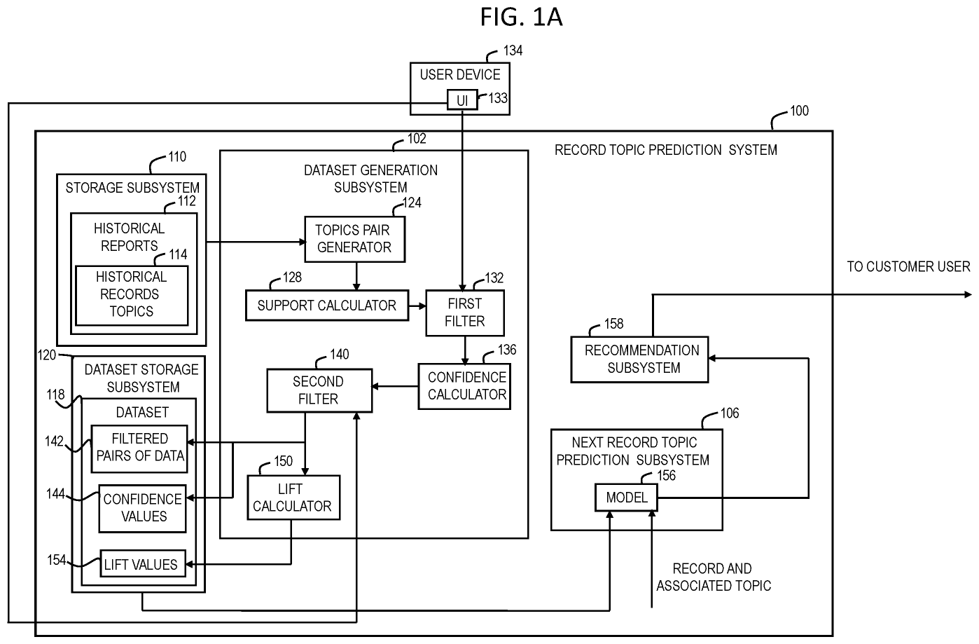

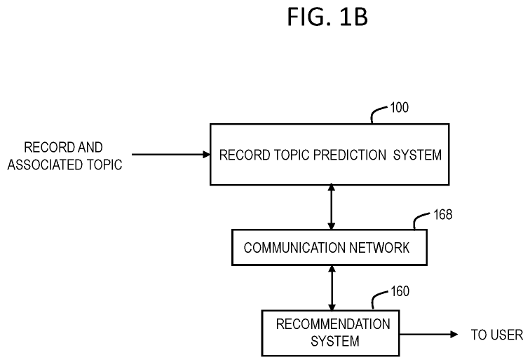

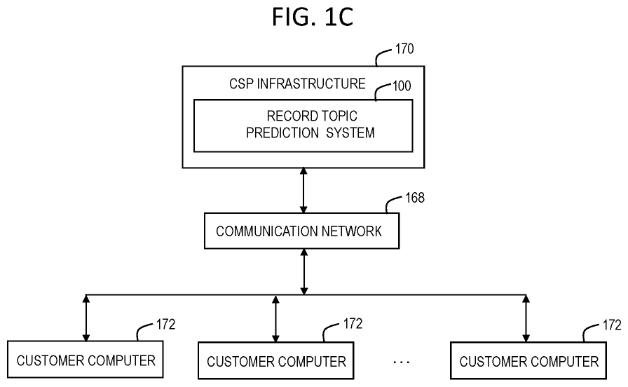

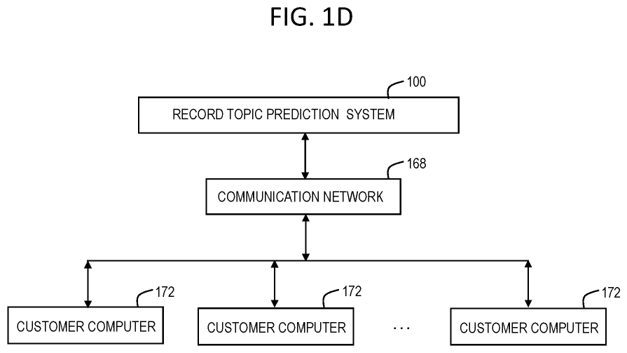

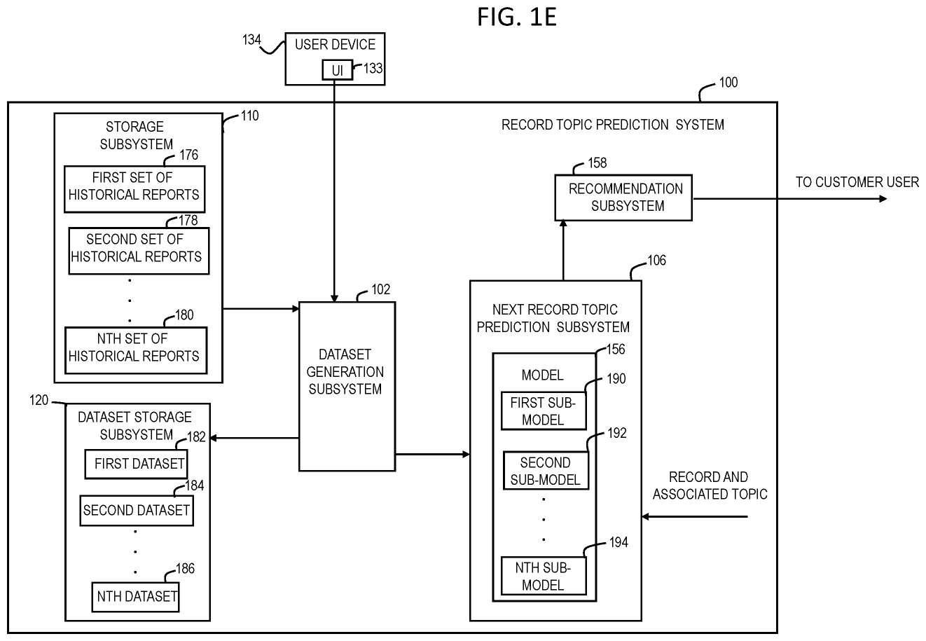

FIG. 1A is a block diagram of a record topic prediction system 100 according to certain embodiments. The record topic prediction system 100 may be implemented using one or more computer systems, each computer system having one or more processors. The record topic prediction system 100 may include multiple components and subsystems communicatively coupled to each other via one or more communication mechanisms.

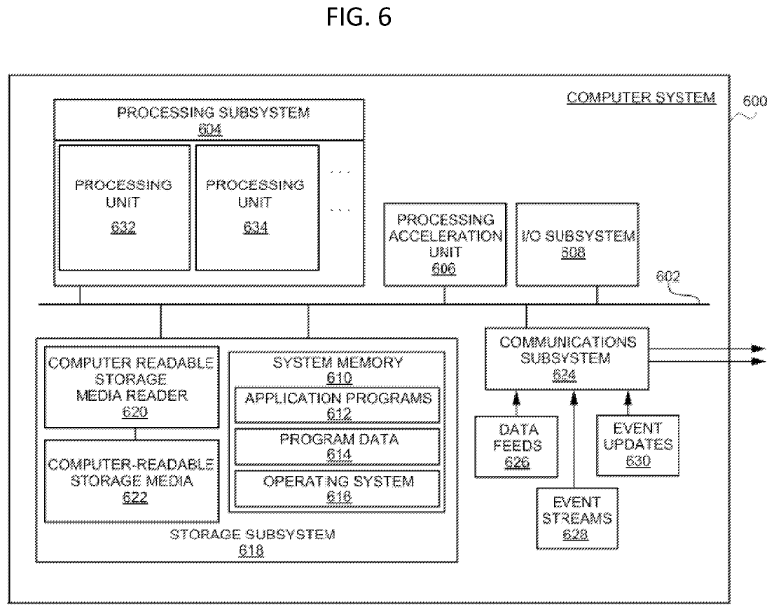

For example, in the embodiment depicted in FIG. 1A, the record topic prediction system 100 includes a dataset generation subsystem 102 and a next record topic prediction subsystem 106. These subsystems may be implemented as one or more computer systems. The systems, subsystems, and other components depicted in FIG. 1A may be implemented in software (e.g., code, instructions, program) executed by one or more processing units (e.g., processors, cores) of the respective systems, using hardware, or combinations thereof. The software may be stored on a non-transitory storage medium (e.g., on a memory device). Record topic prediction system 100 depicted in FIG. 1A is merely an example and is not intended to unduly limit the scope of embodiments. Many variations, alternatives, and modifications are possible. For example, in some implementations, record topic prediction system 100 may have more or fewer subsystems or components than those shown in FIG. 1A, may combine two or more subsystems, or may have a different configuration or arrangement of subsystems. The record topic prediction system 100 and subsystems depicted in FIG. 1A may be implemented using one or more computer systems, such as the computer system depicted in FIG. 6.

As shown in FIG. 1A, the record topic prediction system 100 includes a storage subsystem 110 that may store the various data constructs and programs used by the record topic prediction system 100. For example, the storage subsystem 110 may store various data such as one or more historical reports 112 each including one or more historical records topics 114. However, this is not intended to be limiting. In alternative implementations, the historical reports 112 may be stored in other memory storage locations (e.g., different databases) that are accessible to the record topic prediction system 100, where such memory storage locations can be local to or remote from the record topic prediction system 100. In addition, other data used by the record topic prediction system 100 or generated by the record topic prediction system 100 as a part of its functioning may be stored in the storage subsystem 110. For example, information identifying various threshold(s) and metric(s) used by or determined by the record topic prediction system 100 may be stored in the storage subsystem 110.

In embodiments, the historical reports 112 may correspond to different users or customers, and may include user information, e.g., a user identifier (ID) or a customer ID. In certain implementations, each of the customers may provide a set of the historical reports 112 associated with their users. In other implementations, each of the customers may provide a set of the historical reports 112 associated with their organizations or businesses.

In embodiments, the historical reports may be arranged as sets corresponding to different types of accounts or businesses. Examples of different types of accounts that are associated with individual sets of the historical reports may be personal accounts, corporate accounts, retail accounts, grocery businesses accounts, etc., where each set of the historical reports contains historical reports of different customers within an account group. The historical reports of the same set of the historical reports belong to a same account type group and have the same attributes or context. The various scenarios are described below in more detail with reference to FIG. 1E; however, for simplicity, the description below focuses on an example where one or more customers provide the historical reports 112 associated with their users' accounts.

In some implementations, the record topic prediction system 100 performs a multiple-stage processing including a dataset preparation stage and a record topic prediction stage that are performed by the dataset generation subsystem 102 and the next record topic prediction subsystem 106. Each of the processing stages and the functions performed by the corresponding subsystems are described below in more detail.

At the dataset preparation stage, the record topic prediction system 100 receives, as an input, the historical reports 112 and their associated historical records topics 114, and performs processing on the historical records topics 114. At the record topic prediction stage, the record topic prediction system 100 receives, as an input, a record of a user that is associated with a topic and uses the results of processing performed at the dataset preparation stage, to generate a prediction of a next record topic with respect to the user, with high levels of accuracy.

The dataset generation subsystem 102 is configured to perform processing corresponding to the dataset preparation stage. The dataset generation subsystem 102 receives, as an input, the historical reports 112 including the historical records topics 114. The dataset generation subsystem 102 performs processing on the historical records topics 114 that results in the generation of a dataset 118, which is then used as an input for the next record topic prediction subsystem 106. Further, the dataset 118 output by the dataset generation subsystem 102 is stored in a dataset storage subsystem 120.

In certain implementations, the historical reports 112 may be a set of historical transaction data associated with a plurality of accounts, e.g., user identifiers, that is collected over time by the customers and made available to the storage subsystem 110 and/or the record topic prediction system 100. For example, the set of the historical reports 112 may correspond to a plurality of users associated with personal account numbers (PANs), and include historical transaction data corresponding to a variety of records in a plurality of topics. As an example, the historical transaction data may include records from a number of different user accounts and may be collected over a time period, e.g., a year. However, this is not intended to be limiting. The transaction data may be collected for a time period smaller or more than a year.

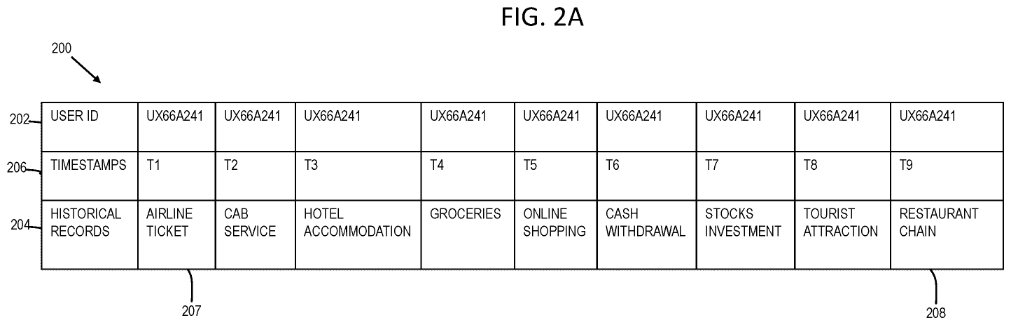

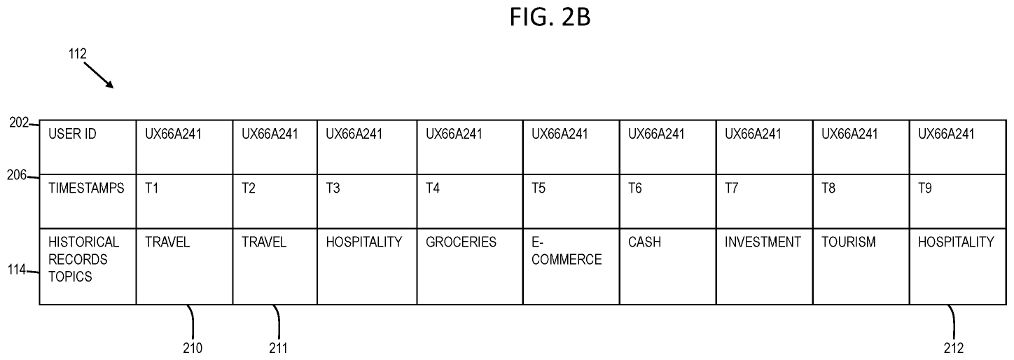

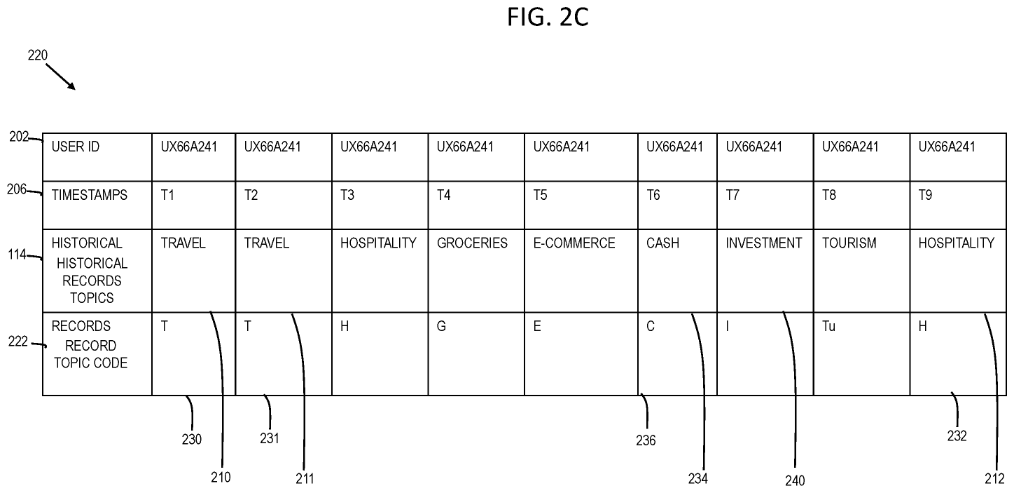

FIG. 2A illustrates an example of a transaction report of a user according to various embodiments.

With reference to FIG. 2A, a transaction report 200 includes a user identifier (ID) 202, historical records 204 (e.g., historical transaction records), and timestamps 206 respectively corresponding to time when a particular transaction, e.g., an event, occurred. The timestamps 206 denote an order in which the events in the transaction report 200 occurred. As shown in FIG. 2A, the historical records 204 include a first historical record 207 to an Nth historical record 208 exemplary including an airline ticket, a cab service, hotel accommodation, groceries, an online shopping, a cash withdrawal, a stocks investment, a tourist attraction, and a restaurant chain, e.g., the historical records of events that occurred in this order. Although not shown in FIG. 2A, each of the historical records 204 is associated with a corresponding record topic as described below with reference to FIG. 2B.

FIG. 2B illustrates an example of one of the historical reports of a user according to various embodiments.

With reference to FIG. 2B, the historical report 112 includes the user ID 202, the timestamps 206, and the historical records topics 114. The historical records topics 114 of FIG. 2B respectively correspond to the historical records 204 shown in FIG. 2A and include a first historical topic 210, and a second historical topic 211 to an Nth historical topic 212. In embodiments, each historical report 112 stored in the storage subsystem 110 includes user information, e.g., user ID, a timeline of occurrences of the event corresponding to the historical records 204 associated with a given user, as represented by the timestamps 206, and the historical records topics 114 corresponding to the historical records associated with that user.

As shown in FIG. 2B, an airline ticket is replaced with travel, a cab service is also replaced with travel, hotel accommodation is replaced with hospitality, groceries remain as a topic, an online shopping is replaced with E-commerce, etc.

In some embodiments, the dataset generation subsystem 102 may include a topics pair generator 124. The topics pair generator 124 receives the historical reports 112 including the historical records topics 114, processes the historical records topics 114 based on information regarding the historical records that is included in the historical reports 112, and generates topics pairs, e.g., pairs of data, based on the each of the historical reports 112 associated with each of the user IDs. Each pair of data generated by the topics pair generator 124 includes a topic sequence including an antecedent topic and a consequent topic. An “antecedent—consequent” is a concept that means that if a first event happens, e.g., corresponding to an “antecedent topic,” then a second event happens, e.g., corresponding to a “consequent topic.” Accordingly, in the topic sequence including the antecedent topic and the consequent topic, the first event corresponding to the antecedent topic must happen before the second event corresponding to the consequent topic could happen. That is, the next event corresponding to the consequent topic will likely happen if the first event corresponding to the antecedent topic happened.

From an example of FIG. 2B, a rule may be deduced by which if the tourism happens (“antecedent topic”), it is likely that the hospitality is to follow (“consequent topic”).

FIG. 2C illustrates an example of a result of processing performed by the dataset generation subsystem 102 according to various embodiments.

In an example 220 of FIG. 2C, the user ID 202, the timestamps 206, and the historical records topics 114 are the same as described above with reference to FIGS. 2A and 2B. The topics pair generator 124 may receive the historical report 112 of the user and assign a record topic code 222 to each of the historical records topics 114, where a first topic code 230, and a second topic code 231 to an Nth topic code 232 may be assigned in correspondence to the first historical topic 210 to the Nth historical topic 212. As exemplary shown in FIG. 2C, the travel is assigned a code “T”, hospitality is assigned a code “H”, groceries is assigned a code “G”, E-commerce is assigned a code “E”, cash is assigned a code “C”, investment is assigned a code “I”, and tourism is assigned a code “Tu.”

Based on the timestamps 206 of the historical records that are included in the historical report 112 of the user, the topics pair generator 124 may extract a topic sequence {T, T, H, G, E, C, I, Tu, H} and may form pairs of data including an antecedent topic and a consequent topic based on the extracted topic sequence. In the topic sequence extracted from the historical report 112, each topic corresponding to a historical record corresponding to a preceding event, may be considered an antecedent topic and each topic corresponding to a historical record corresponding to a subsequent event, may be considered a consequent topic.

For example, considering the first historical topic 210 “travel,” to which the record topic code “T” is assigned, as corresponding to the antecedent topic, the topics pair generator 124 may form the following pairs of data, each including an antecedent topic (coded as “T” for the first historical topic 210 “travel”) and a consequent topic including one of the second historical topic 211 (coded as “T”) to the Nth historical topic 212 (coded as “H”):
1. {T,T}
2. {T,H}
3. {T,G}
4. {T,E}
5. {T,C}
6. {T,I}
7. {T, Tu}
8. {T,H}

As another example, considering an mth historical topic 234 “cash,” to which the record topic code 236 “C” is assigned, as corresponding to the antecedent topic, the topics pair generator 124 may form the following pairs of data, each including an antecedent topic (coded as “C” for the mth historical topic 234 “cash”) and a consequent topic including (m+1) historical topic 240 (coded as “I”) to the Nth historical topic 212 (coded as “H”):
1. {C,I}
2. {C, Tu}
3. {C,H}

However, the described-above is not limiting. Although an example where the topics pair generator 124 forms the pairs of data with only one consequent topic for every antecedent topic is described (e.g., two-element topic sequences), the process can also be performed where a topic sequence is formed having one antecedent topic and two or more consequent topics. E.g., for the antecedent topic “cash,” the three-element topic sequences may be formed as:
1. {C, I, Tu}
2. {C, I, H}
3. {C, Tu, H}

Herein, the description of embodiments focuses on the two-element topic sequences, e.g., the pairs of data including one antecedent topic and one consequent topic, for simplicity of description.

The described-above process is performed exhaustively for all the accounts, e.g., user personal accounts, corporate accounts, etc., across the historical reports 112 that are collected over time. As a result of the processing performed the topics pair generator 124, a set of pairs of data each including an antecedent topic and a consequent topic is generated, where the set of pairs of data includes certain patterns usable by an ML model.

Referring again to FIG. 1A, the dataset generation subsystem 102 further includes a support calculator 128 and a first filter 132. The support calculator 128 receives, as an input, the pairs of data generated by the topics pair generator 124, and calculates a support value for each of the pairs of data.

The support value is a measure of the frequency with which each pair of data appears in the set of the pairs of data generated by the topics pair generator 124. For example, “Tourism” and “Hospitality” might appear together in 40% of the pairs of data. Then, each of the following rules has a support of 40%:
Tourism implies Hospitality
Hospitality implies Tourism

Support value may be calculated as the ratio of the pairs of data that include all items corresponding to a given antecedent topic and a given consequent topic to the number of total historical records associated with the historical reports 112 processed by the topics pair generator 124, according to Equation 1:

Support (A)=(Number of pairs of data containing A)/(Total number of historical records),
where a dividend is a number of times that two topics appear together in the pairs of data. “A” refers to a combination of a same first topic and a same second topic included together in the pairs of data, where the first topic may be an antecedent topic or a consequent topic, and the second topic may be an antecedent topic or a consequent topic.

Table 1 below provides examples of the support values calculated for a topic sequence {B, C, D, E}, where the topic sequences are formed as two-element topic sequences and three-element topic sequences. It is assumed that a total number of historical records is 3.

TABLE 1

| Transaction Pair | Frequency | Support |
|---|---|---|
| (B, C) | 2 of 3 | 67% |
| (B, D) | 2 of 3 | 67% |
| (B, E) | 3 of 3 | 100% |
| (C, E) | 2 of 3 | 67% |
| (D, E) | 2 of 3 | 67% |
| (B, C, E) | 2 of 3 | 67% |
| (B, D, E) | 2 of 3 | 67% |

As shown in Table 1, topics “B” and “C” appear together in two instances, i.e., in (B, C) and (B, C, E). Accordingly, the support value for a combination of topics “B” and “C” is calculated as 67%. The remaining support values in Table 1 are calculated in a similar manner.

The first filter 132 is configured to remove the pairs of data having the support value smaller than or equal to a first predetermined threshold value, and output the pairs of data having the support value greater than the first predetermined threshold value. In some embodiments, the first predetermined threshold value may be configurable and/or changeable by the customer by providing an input via a user interface (UI) 133 of a user device 134. In other embodiments, the first predetermined threshold value may be preconfigured and stored, e.g., in the storage subsystem 110.

The dataset generation subsystem 102 may include a confidence calculator 136 and a second filter 140.

The confidence calculator 136 is configured to receive, as an input, the pairs of data having associated support values greater than the first predetermined threshold value, e.g., the pairs of data that underwent the first filtering, and calculate a confidence value for these pairs of data.

Confidence value is a parameter that depicts how likely an event “B” occurs if event “A” has already occurred. For example, topic “Tourism” corresponds to 50 instances in the historical records, where 40 of 50 occurrences of topic “Tourism” may be an antecedent topic included in the pairs of data that also include topic “Hospitality” as a consequent topic. The rule of confidence may be—Tourism implies Hospitality with 80% confidence. I.e., the confidence value is a ratio of a number of the pairs of data containing the same antecedent topic followed by the same consequent topic to a number of all occurrences of the antecedent topic in the historical records.

The confidence value relates to the frequency with which a rule or a relationship is observable. On many occasions, when a person conducts a transaction related to the tourism, the next transactions of this person most likely correspond to hospitality, travel, and/or dining. Therefore, confidence is a measure that provides a likelihood of the consequent topic in the pair of data to appear when the antecedent topic corresponding to a preceding event has already happened.

The confidence value can be expressed by Equation 2:

Confidence (A→B)=Support (AUB)/Support (A),
where a dividend is a support value for a topic A being an antecedent topic in the pairs of data where topics A and B appear together, and
a divisor is a support value for topic A occurring in all the historical records.

Table 2 below provides examples of the confidence values calculated for a topic sequence {B, C, D, E} discussed above with reference to Table 1.

TABLE 2

| Transaction | | Prob(Consequent) f | |
|---|---|---|---|
| Pair | Rule | Prob(Antecedent) | Confidence |
| (B, C) | (If B then C) | 67/100 | 67% |
| | (If C then B) | 67/67 | 100% |
| (B, D) | (If B then D) | 67/100 | 67% |
| | (If D then B) | 67/67 | 100% |
| (B, E) | (If B then E) | 100/100 | 100% |
| | (If E then B) | 100/100 | 100% |
| (C, E) | (If C then E) | 67/67 | 100% |
| | (If E then C) | 67/100 | 67% |
| (D, E) | (If D then E) | 67/67 | 100% |
| | (If E then D) | 67/100 | 67% |
| (B, C, E) | (If B and C then E) | 67/67 | 100% |
| | (If B and E then C) | 67/100 | 67% |
| | (If C and E then B) | 67/67 | 100% |
| (B, D, E) | (If B and D then E) | 67/67 | 100% |
| | (If B and E then D) | 67/100 | 67% |
| | (If D and E then B) | 67/67 | 100% |

In an example of the pair of data (B, C), the confidence value of C happening after occurrence of B is 67%. The confidence value of C occurring after B is 100%. The remaining confidence values in Table 2 are calculated in a similar manner.

The second filter 140 is configured to remove the pairs of data having the confidence value smaller than or equal to a second predetermined threshold value, and output the pairs of data having the confidence value greater than the second predetermined threshold value. In some embodiments, the second predetermined threshold value may be configurable and/or changeable by the customer by providing an input via the UI 133. In other embodiments, the second predetermined threshold value may be preconfigured and stored, e.g., in the storage subsystem 110.

As a result of the processing performed by the second filter 140, filtered pairs of data 142 that underwent the second filtering are stored in the dataset storage subsystem 120 in association with corresponding confidence values 144.

In embodiments, the dataset generation subsystem 102 may include a lift calculator 150. The lift calculator 150 is configured to receive the filtered pairs of data 142 that underwent the second filtering, and calculate a lift value for each of the filtered pairs of data 142. Lift value quantifies the quality of the pairs of the data obtained thus far and helps to mitigate an issue that is accuracy by volume. For instance, if a user buys groceries 80% of the time, the support value for the pairs having groceries as a topic is high. If one of the user's record topics is tourism, there is a high likelihood that the groceries will be paired with tourism because the groceries is a topic corresponding to a frequent event and occur often. In this case, the tourism and groceries pair can have a high support value and a high confidence value.

Accordingly, the lift value is a measure for evaluating the quality of the rule. Lift value indicates the strength of a rule over the random co-occurrence of the antecedent topic and the consequent topic, given their support. It provides information about the improvement, and the increase in the probability of the occurrence of the consequent topic given the antecedent topic. The lift value can be calculated according to Equation 3:

Lift (A⇒B)=Confidence (A⇒B)/Support (B),
where a dividend is a confidence value with respect to a topic B corresponding to an event occurring after an occurrence of an event corresponding to a topic A, and
a divisor is a support value for the consequent topic B.

In an example, the pair of data where “tourism” (“antecedent topic”) is followed by “groceries” (“consequent topic”) has a 75% confidence value. The combination of “tourism” and “groceries” has a support value of 30%. That is, both the confidence value and the support value for the pair (Tu, G) are quite high. However, if the historical records contain 90% of the topic “groceries,” then the event corresponding to the topic “tourism” is much smaller likely to occur than the topic “groceries” among the historical records, e.g., 40% of the time. If, in the pair of data, the support value for the antecedent topic is much smaller than the support value for the consequent topic, it indicates that the pattern is not repetitive and, as such, is not conducive to a constructive and usable prediction for the next record topic.

For the above example, using the Equation 3, the lift value can be calculated as 75%/90%=0.83.

The lift values 154 calculated by the lift calculator 150 are stored in the dataset storage subsystem 120 in association with the filtered pairs of data 142. However, this is not intended to be limiting. In certain implementations, the dataset generation subsystem 102 may remove the pairs of data whose lift value is smaller than a third predetermined threshold value, e.g., 1, from the further processing. In these implementations, the filtered pairs of data stored in the dataset storage subsystem 120 have lift values greater than the third predetermined threshold value. The third predetermined threshold value may be configurable and/or changeable by the customer by providing an input via the UI 133. In other embodiments, the third predetermined threshold value may be preconfigured and stored, e.g., in the storage subsystem 110.

The next record topic prediction subsystem 106 is configured to perform processing corresponding to the next record topic prediction stage. The next record topic prediction subsystem 106 receives as an input, the dataset 118, a record corresponding to an event with respect to a certain user, and a topic associated with the record. As a result of the processing performed at the next record topic prediction stage, the next record topic prediction subsystem 106 is configured to output one or more predictions regarding the potential topics of the next record related to the same user.

In certain implementation, the next record topic prediction subsystem 106 includes a model 156, e.g., a machine learning (ML) model. The model 156 may be a model of a predetermined architecture and may be trained to perform processing using unsupervised learning algorithms.

A “machine learning model” can refer to a software module configured to be run on one or more processors to provide a classification or numerical value of a property of one or more data samples. Example models may include different approaches and algorithms including analytical learning, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, statistical relational learning, or Proaftn, a multicriteria classification algorithm.

The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein.

Further, the machine learning models can include, but not limited to, convolutional neural network (CNN), linear regression, logistic regression, deep recurrent neural network (e.g., fully-connected recurrent neural network (RNN), Gated Recurrent Unit (GRU), long short-term memory, (LSTM)), transformed-based methods (e.g. XLNet, BERT, XLM, RoBERTa), Bayes' classifier, hidden Markov model (HMM), linear discriminant analysis (LDA), k-means clustering, density-based spatial clustering of applications with noise (DBSCAN), random forest algorithm, adaptive boosting (AdaBoost), eXtreme Gradient Boosting (XGBoost), support vector machine (SVM), or a composite model including one or more models discussed above.

Referring again to FIG. 1A, the model 156 receives as an input, the filtered pairs of data 142, the confidence values 144, and the lift values 154 that are included in the dataset 118 and associated with each other. The model 156 further receives as an input, a record corresponding to an event with respect to a certain user, and a topic associated with the record. Herein, a record of a certain user is referred to as a user record corresponding to a first event and a topic associated with the user record is referred to as an input topic corresponding to the first event.

The model 156 uses the filtered pairs of data 142 to determine pairs of data containing the antecedent topic corresponding to the input topic. The model 156 identifies the consequent topics in the pairs of data, which contain the antecedent topic corresponding to the input topic, as candidate topics corresponding to the next record of the certain user. For example, the next record of the certain user may correspond to a second event that is a potential event estimated to happen after the first event.

In certain implementations, the model 156 may sort the candidate topics in the descending order based on the confidence values associated with the pairs of data from which the candidate topics were identified. The model 156 may identify a number of the candidate topics having the greatest confidence values, e.g., greater than a fourth predetermined threshold value. The fourth predetermined threshold value may be configurable and/or changeable by the customer by providing an input via the UI 133. In other embodiments, the fourth predetermined threshold value may be preconfigured and stored, e.g., in the storage subsystem 110.

In some instances, the model 156 may select a first number of the candidate topics having the greatest confidence values, where the first number of the candidate topics to be selected is configurable by a customer and may be 2, 3, 5, . . . , 10.

In some instances, the model 156 can use the lift values associated with the pairs of data from which the selected candidate topics were identified, to further limit a number of the candidate topics to the best candidates. The model 156 may select a second number of the final topics having the greatest lift values among the selected candidate topics, and output the final topics as predictions for the next record topics estimated to occur in the near future. The second number is configurable by a customer and may be not smaller than 1, but smaller than the first number.

In certain implementations, the model 156 can order the pairs of data in an order of decreasing confidence values, and identify, as a first result group, first pairs of data among the pairs of data that have greatest confidence values, where a number of the first pairs of data is defined to be greater than 1 and smaller than a predetermined first number. The model 156 can further identify, as a second result group, second pairs of data from the first result group that have greatest lift values, where a number of the second pairs of data is defined to be not smaller than 1 and smaller than the predetermined first number. The model 156 can generate one or more predictions based on the second pairs of data, and output one or more predictions.

As described above, in various embodiments, rules are established that allow the record topic prediction system 100 to predict future record topics with high confidence with the added validation of lift. As described above, the confidence value quantifies the happening of event B after A. But if the support value for event A occurring is too small, the rule may produce predictions that are not productive in practice. Accordingly, the lift value validates a supposition that A occurring before B improves the chances of B taking the place, e.g., the event B is not happening by mere chance.

In certain implementations, the model 156 may output one or more sequences of predictions corresponding to events that could happen sequentially in the near future.

In certain implementations, the record topic prediction system 100 may include a recommendation subsystem 158. The recommendation subsystem 158 is configured to receive, an input, the predictions for the next record topics, and generate a recommendation, e.g., a message, for the certain user. The examples of the message include a service discount, a promotion, an advertisement, etc.

In the related art, the promotions and advertisements are generally time-based, e.g., are based on a day of the week or a time of the year. Unlike the related art methods, in embodiments, the recommendation subsystem 158 provides a targeted message based on the accurately derived predictions for the next record topic.

The described above is not intended to be limiting. In some instances, the record topic prediction system 100 does not include the recommendation subsystem 158.

As exemplary shown in FIG. 1B, a recommendation system 160 may be provided separately from the record topic prediction system 100, and may be connected to the record topic prediction system 100 via a communication network 168.

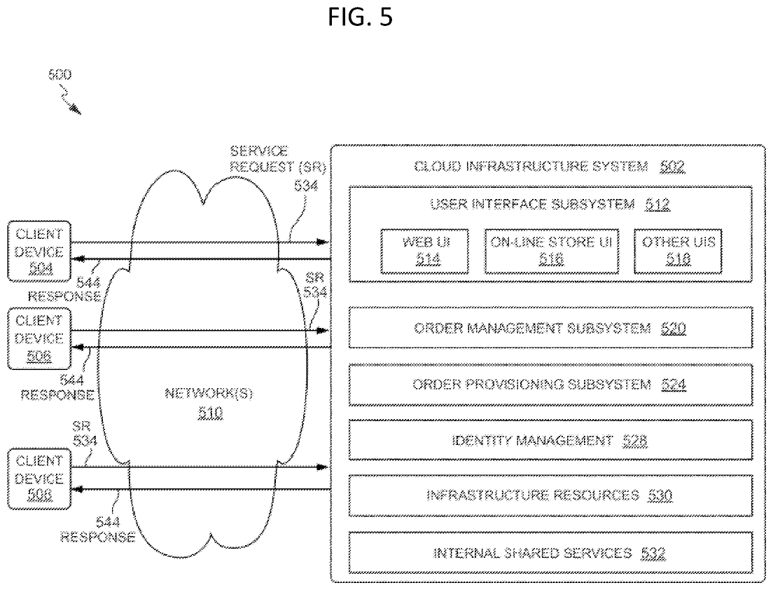

As shown in FIG. 1C, the record topic prediction system 100 may be a part of a CSP infrastructure 170 provided by a CSP for providing one or more cloud services to one or more customer computers 172. Example of a cloud infrastructure architecture provided by the CSP is depicted in FIG. 5 and described in detail below.

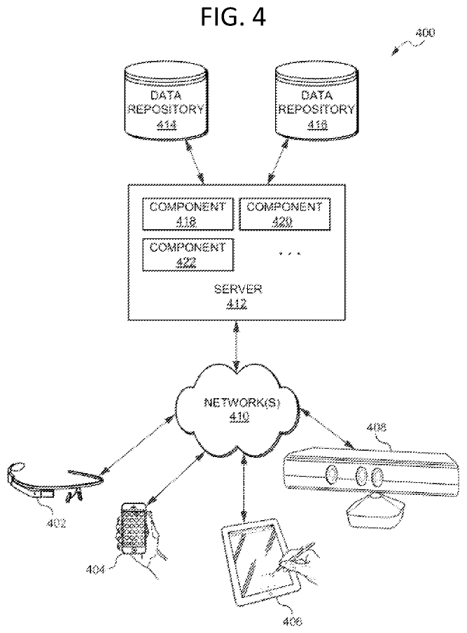

As shown in FIG. 1D, the record topic prediction system 100 can be provided as a part of a distributed computing environment, where the record topic prediction system 100 is connected to one or more customer computers 172 via a communication network 168. Example of a distributed computing environment is depicted in FIG. 4 and described in detail below.

FIG. 1E depicts a simplified block diagram of a record topic prediction system in accordance with various embodiments.

In embodiments, the historical reports may be arranged as sets corresponding to different types of accounts or businesses. Examples of different types of accounts that are associated with individual sets of the historical reports may be personal accounts, corporate accounts, retail accounts, grocery businesses accounts, etc., where each set of the historical reports contains historical reports of different customers within an account group. The historical reports of the same set of the historical reports belong to a same account group and have the same attributes or context.

As exemplary depicted in FIG. 1E, the storage subsystem 110 may store a plurality of sets of historical reports including a first set of historical reports 176 and a second set of historical reports 178 to an Nth set of historical reports 180. However, this is not intended to be limiting. The plurality of sets of historical reports may be stored in the different storage media. Further, a number of the sets of historical reports is not limited, and may be any number, e.g., 1, 2, 3, . . . , 10, . . . N. In an example shown in FIG. 1A, only one set of the historical reports 112 is provided and stored.

In embodiments, each of the customers may provide the historical reports associated with their users and/or each of the customers may provide the historical reports 112 associated with their organizations or businesses.

For example, the first set of historical reports 176 may correspond to the historical reports 112 described above with reference to FIG. 1A. The first set of historical reports 176 may be associated with personal accounts of the users of the customers that provided the historical reports included in the first set of historical reports 176. However, this is not intended to be limiting. For example, the first set of historical reports 176 may include subsets of historical reports, where each of the subsets corresponds to and associated with a certain customer. Accordingly, the recommendation subsystem 158 depicted in FIG. 1A may determine the recommendations for the users of the certain customer, e.g., recommendations specific to the business of the certain customer.

As another example, the second set of historical reports 178 may be provided by the customers, where the historical reports are associated with corporate accounts.

As yet another example, the Nth set of historical reports 180 may be provided by the customers, where the historical reports are associated with a particular industry or business, e.g., groceries.

Based on each of the plurality of sets of historical reports, the dataset generation subsystem 102 generates a plurality of datasets. The processing performed by the dataset generation subsystem 102 for each of the plurality of sets of historical reports is the same as described above with reference to FIG. 1A, with respect to the dataset 118. As a result, the plurality of datasets is generated, including a first dataset 182 and a second dataset 184 to an Nth dataset 186, respectively corresponding to the first set of historical reports 176 to the Nth set of historical reports 180. The dataset generation subsystem 102 may generate the first dataset 182 to the Nth dataset 186 partially in parallel, in parallel, successively, or on as needed basis.

The next record topic prediction subsystem 106 receives, as an input, an input topic of a record corresponding to one of the account groups. The next record topic prediction subsystem 106 may access one of the first dataset 182 to the Nth dataset 186 that corresponds to that account group, and use the model 156 to generate one or more predictions of one or more record topics with respect to the input topic. When more than one input topic is received that corresponds to more than one of the account groups, the next record topic prediction subsystem 106 performs processing with respect to the input topics partially in parallel, in parallel, successively, or on as needed basis. The operations performed by the next record topic prediction subsystem 106 with respect to the input topic are similar to those described above with reference to FIG. 1A.

In certain implementations, the model 156 includes a first sub-model 190 and a second sub-model 192 to an Nth sub-model 194. Each of the first sub-model 190 to the Nth sub-model 194 is configured to perform processing performed by the model 156 that is described in detail above with respect to FIG. 1A, using each of the first dataset 182 to the Nth dataset 186, respectively, and an input topic provided according to a corresponding one of the plurality of sets of the historical reports. However, this is not intended to be limiting, and a set of separate models may be used.

In embodiments, the customers may provide their sets of the historical reports on a periodical basis, to update their corresponding datasets.

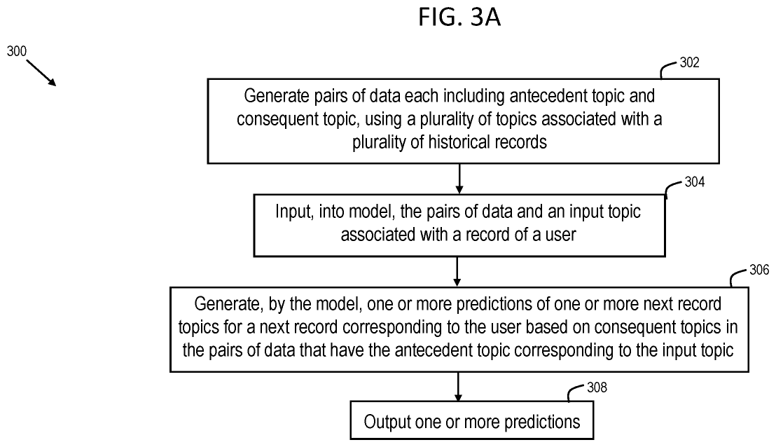

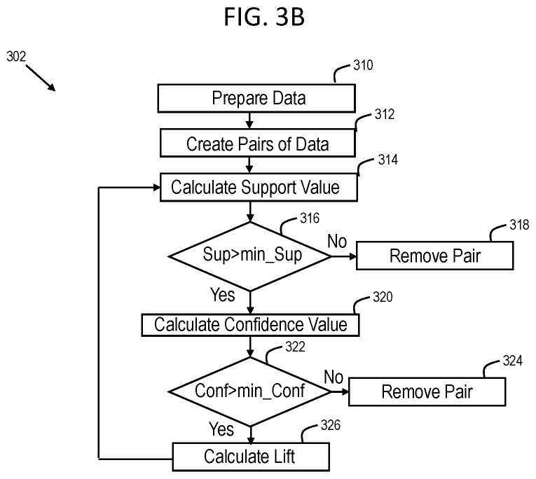

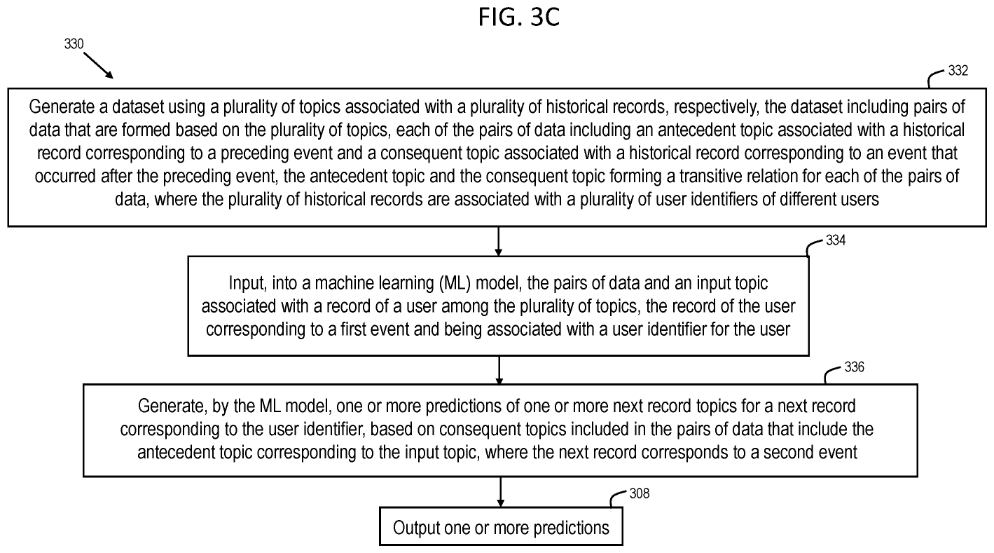

FIG. 3A depicts a simplified flowchart depicting processing 300 performed by the record topic prediction system 100, according to certain embodiments. For example, the processing 300 depicted in FIG. 3A may be performed by the dataset generation subsystem 102 and the next record topic prediction subsystem 106.

The processing 300 depicted in FIG. 3A may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 3A and described below is intended to be illustrative and non-limiting. Although FIG. 3A depicts the various processing operations occurring in a particular sequence or order, this is not intended to be limiting. In certain alternative embodiments, the processing 300 may be performed in some different order or some operations may be performed in parallel.

With continuing reference to FIG. 3A and referring again to FIG. 1A, at 302, the dataset generation subsystem 102 generates the pairs of data each including an antecedent topic and a consequent topic, using a plurality of topics associated with a plurality of historical records. The processing performed at 302 is described in more detail below.

At 304, the dataset generation subsystem 102 provides, as an input, the pairs of data to the model 156 of the next record topic prediction subsystem 106. The model 156 also receives, as an input, an input topic associated with a record of a user.

At 306, the model 156 generates one or more predictions of one or more next record topics for a next record corresponding to the user based on the consequent topics in the pairs of data that have the antecedent topic corresponding to the input topic.

At 308, the next record topic prediction subsystem 106 outputs the prediction(s).

FIG. 3B depicts a simplified flowchart depicting processing 302 performed by the record topic prediction system 100, according to certain embodiments. For example, the processing 302 depicted in FIG. 3B may be performed by the dataset generation subsystem 102.

The processing 302 depicted in FIG. 3B may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 3B and described below is intended to be illustrative and non-limiting. Although FIG. 3B depicts the various processing operations occurring in a particular sequence or order, this is not intended to be limiting. In certain alternative embodiments, the processing 302 may be performed in some different order or some operations may be performed in parallel.

With continuing reference to FIG. 3B and referring again to FIG. 1A, at 310, the topics pair generator 124 prepares data. The topics pair generator 124 receives the historical reports 112 including the historical records topics 114, and processes the historical records topics 114 based on information regarding the historical records that is included in each historical report 112 corresponding to the user ID.

At 312, the topics pair generator 124 creates pairs of data, each including an antecedent topic and a consequent topic based on timestamps included in the historical reports 112.

At 314, the support calculator 128 calculates a support value for the pair of data.

At 316, the first filter 132 compares the support value to the first predetermined threshold value.

If, at 316, it is determined that the support value of the pair of data is not greater than the first predetermined threshold value, the processing proceeds to 318 where the pair of data with a low support value is removed from further processing.

If, at 316, it is determined that the support value of the pair of data is greater than the first predetermined threshold value, the processing proceeds to 320.

At 320, the confidence calculator 136 receives, as an input, the pair of data having associated support value greater than the first predetermined threshold value, and calculates a confidence value for the pair of data.

At 322, the second filter 140 compares the confidence value to the second predetermined threshold value.

If, at 324, it is determined that the confidence value of the pair of data is not greater than the second predetermined threshold value, the processing proceeds to 326 where the pair of data with a low confidence value is removed from further processing.

If, at 324, it is determined that the confidence value of the pair of data is greater than the second predetermined threshold value, the processing proceeds to 326.

At 326, the lift calculator 150 receives the filtered pair of data, and calculates a lift value for the filtered pair of data.

The processing returns to 314, to process the next pair of data.

As a result of the processing 302, the filtered pairs of data, the confidence values, and the lift values are generated and stored in the dataset storage subsystem 120.

FIG. 3C depicts a simplified flowchart depicting processing 330 performed by the record topic prediction system 100, according to certain embodiments. For example, the processing 330 depicted in FIG. 3C may be performed by the dataset generation subsystem 102 and the next record topic prediction subsystem 106.

The processing 330 depicted in FIG. 3C may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 3C and described below is intended to be illustrative and non-limiting. Although FIG. 3C depicts the various processing operations occurring in a particular sequence or order, this is not intended to be limiting. In certain alternative embodiments, the processing 330 may be performed in some different order or some operations may be performed in parallel.

With continuing reference to FIG. 3C and referring again to FIG. 1A, at 332, the dataset generation subsystem 102 generates a dataset 118 using a plurality of topics associated with a plurality of historical records, respectively. The dataset includes pairs of data that are formed based on the plurality of topics. Each of the pairs of data includes an antecedent topic associated with a historical record corresponding to a preceding event and a consequent topic associated with a historical record corresponding to an event that occurred after the preceding event, the antecedent topic and the consequent topic forming a transitive relation for each of the pairs of data. The plurality of historical records are associated with a plurality of user identifiers of different users.

In some instances, the dataset generation subsystem 102 generates the dataset 118 by obtaining historical reports 112 for the plurality of user identifiers, respectively, where each respective historical report includes topics associated with a respective historical record associated with one of the plurality of user identifiers. For example, the topics are arranged in a sequence based on a timeline. The dataset generation subsystem 102 further generates the dataset 118 by forming each of the pairs of data to include a first topic associated with a first time point on the timeline and a second topic associated with a second time point on the timeline that is later in time than the first time point, as the antecedent topic and the consequent topic, respectively.

The processing performed at 332 corresponds to the processing 302 described above.

At 334, the dataset generation subsystem 102 provides, as an input, the pairs of data to the model 156 of the next record topic prediction subsystem 106. The model 156 also receives, as an input, an input topic associated with a record of a user, the record of the user corresponding to a first event and being associated with a user identifier for the user. The processing performed at 334 corresponds to the processing 304 described above.

At 336, the model 156 generates one or more predictions of one or more next record topics for a next record corresponding to the user identifier, based on the consequent topic included in each of the pairs of data that include the antecedent topic corresponding to the input topic, where the next record corresponds to a second event, e.g., an event having a potential to happen in the near future, with respect to the user. The processing performed at 336 corresponds to the processing 306 described above.

At 308, the next record topic prediction subsystem 106 outputs the prediction(s).

### Illustrative Systems

FIG. 4 depicts a simplified diagram of a distributed system 400. In the illustrated example, distributed system 400 includes one or more client computing devices 402, 404, 406, and 408, coupled to a server 412 via one or more communication networks 410. Client computing devices 402, 404, 406, and 408 may be configured to execute one or more applications. In certain implementations, the record topic prediction system 100 may reside at the server 412.

In various examples, server 412 may be adapted to run one or more services or software applications that enable one or more embodiments described in this disclosure. In certain examples, server 412 may also provide other services or software applications that may include non-virtual and virtual environments. In some examples, these services may be offered as web-based or cloud services, such as under a Software as a Service (SaaS) model to the users of client computing devices 402, 404, 406, and/or 408. Users operating client computing devices 402, 404, 406, and/or 408 may in turn utilize one or more client applications to interact with server 412 to utilize the services provided by these components.

In the configuration depicted in FIG. 4, server 412 may include one or more components 418, 420 and 422 that implement the functions performed by server 412. These components may include software components that may be executed by one or more processors, hardware components, or combinations thereof. It should be appreciated that various different system configurations are possible, which may be different from distributed system 400. The example shown in FIG. 4 is thus one example of a distributed system for implementing an example system and is not intended to be limiting.

Users may use client computing devices 402, 404, 406, and/or 408 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 4 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 410 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 410 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 412 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 412 may include one or more virtual machines running virtual operating systems, or other computing architectures involving virtualization such as one or more flexible pools of logical storage devices that may be virtualized to maintain virtual storage devices for the server. In various examples, server 412 may be adapted to run one or more services or software applications that provide the functionality described in the foregoing disclosure.

The computing systems in server 412 may run one or more operating systems including any of those discussed above, as well as any commercially available server operating system. Server 412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 412 may include one or more applications to analyze and consolidate data feeds and/or event updates received from users of client computing devices 402, 404, 406, and 408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 412 may also include one or more applications to display the data feeds and/or real-time events via one or more display devices of client computing devices 402, 404, 406, and 408.

Distributed system 400 may also include one or more data repositories 414, 416. These data repositories may be used to store data and other information in certain examples. For example, one or more of the data repositories 414, 416 may be used to store information such as information related to machine-learning model performance or generated machine-learning model for use by server 412 when performing various functions in accordance with various embodiments. Data repositories 414, 416 may reside in a variety of locations. For example, a data repository used by server 412 may be local to server 412 or may be remote from server 412 and in communication with server 412 via a network-based or dedicated connection. Data repositories 414, 416 may be of different types. In certain examples, a data repository used by server 412 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 414, 416 may also be used by applications to store application data. The data repositories used by applications may be of different types such as, for example, a key-value store repository, an object store repository, or a general storage repository supported by a file system.

In certain examples, the functionalities described in this disclosure may be offered as services via a cloud environment. FIG. 5 is a simplified block diagram of a cloud-based system environment in which various services may be offered as cloud services in accordance with certain examples. In the example depicted in FIG. 5, cloud infrastructure system 502 may provide one or more cloud services that may be requested by users using one or more client computing devices 504, 506, and 508. Cloud infrastructure system 502 may include one or more computers and/or servers that may include those described above for server 412. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The example depicted in FIG. 5 is only one example of a cloud infrastructure system and is not intended to be limiting. It should be appreciated that, in some other examples, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative examples.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the customer's own on-premises servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 502 may provide one or more cloud services using different models such as under a Software as a Service (SaaS) model, a Platform as a Service (PaaS) model, an Infrastructure as a Service (IaaS) model, and others, including hybrid service models. Cloud infrastructure system 502 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 502. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 502. Cloud infrastructure system 502 then performs processing to provide the services requested in the customer's subscription order. For example, a user may use utterances to request the cloud infrastructure system to take a certain action (e.g., an intent), as described above, and/or provide services for a record topic prediction system as described herein. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public customer, where the customer may be an individual or an enterprise. In certain other examples, under a private cloud model, cloud infrastructure system 502 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 502 and the services provided may be shared by several organizations in a related community. Various other models such as hybrids of the above mentioned models may also be used.

Client computing devices 504, 506, and 508 may be of different types (such as client computing devices 402, 404, 406, and 408 depicted in FIG. 4) and may be capable of operating one or more client applications. A user may use a client device to interact with cloud infrastructure system 502, such as to request a service provided by cloud infrastructure system 502. For example, a user may use a client device to request information or action from a record topic prediction system as described in this disclosure, or from another system.

In some examples, the processing performed by cloud infrastructure system 502 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 502 for generating and training one or more models for a machine-learning recommendation system. The data used for this analysis may include structured data (e.g., data stored in a database or structured according to a structured model) and/or unstructured data (e.g., data blobs (binary large objects)).

As depicted in the example in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like. In certain examples, the storage virtual machines that are available for servicing storage requested from applications may be part of cloud infrastructure system 502. In other examples, the storage virtual machines may be part of different systems.

In certain examples, to facilitate efficient provisioning of these resources for supporting the various cloud services provided by cloud infrastructure system 502 for different customers, the resources may be bundled into sets of resources or resource modules (also referred to as “pods”). Each resource module or pod may include a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may include multiple subsystems. These subsystems may be implemented in software, or hardware, or combinations thereof. As depicted in FIG. 5, the subsystems may include a user interface subsystem 512 that enables users or customers of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a customer may, using a client device, request (service request 534) one or more services provided by cloud infrastructure system 502 using one or more of interfaces 514, 516, and 518. For example, a customer may access the online store, browse cloud services offered by cloud infrastructure system 502, and place a subscription order for one or more services offered by cloud infrastructure system 502 that the customer wishes to subscribe to. The service request may include information identifying the customer and one or more services that the customer desires to subscribe to. For example, a customer may place a subscription order for a service offered by cloud infrastructure system 502. As part of the order, the customer may provide information identifying a machine-learning recommendation system for which the service is to be provided and optionally one or more credentials for the machine-learning recommendation system.

In certain examples, such as the example depicted in FIG. 5, cloud infrastructure system 502 may include an order management subsystem (OMS) 520 that is configured to process the new order. As part of this processing, OMS 520 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 520 may then invoke the order provisioning subsystem (OPS) 524 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 502 as part of the provisioning process. Cloud infrastructure system 502 may generate an application ID and select a storage virtual machine for an application from among storage virtual machines provided by cloud infrastructure system 502 itself or from storage virtual machines provided by other systems other than cloud infrastructure system 502.

Cloud infrastructure system 502 may send a response or notification 544 to the requesting customer to indicate when the requested service is now ready for use. In some instances, information (e.g., a link) may be sent to the customer that enables the customer to start using and availing the benefits of the requested services. In certain examples, for a customer requesting the service, the response may include a machine-learning recommendation system ID generated by cloud infrastructure system 502 and information identifying a machine-learning recommendation system selected by cloud infrastructure system 502 for the machine-learning recommendation system corresponding to the machine-learning recommendation system ID.

Cloud infrastructure system 502 may provide services to multiple customers. For each customer, cloud infrastructure system 502 is responsible for managing information related to one or more subscription orders received from the customer, maintaining customer data related to the orders, and providing the requested services to the customer. Cloud infrastructure system 502 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 502 may provide services to multiple customers in parallel. Cloud infrastructure system 502 may store information for these customers, including possibly proprietary information. In certain examples, cloud infrastructure system 502 includes an identity management subsystem (IMS) 528 that is configured to manage customer information and provide the separation of the managed information such that information related to one customer is not accessible by another customer. IMS 528 may be configured to provide various security-related services such as identity services, such as information access management, authentication and authorization services, services for managing customer identities and roles and related capabilities, and the like.

FIG. 6 illustrates an example of computer system 600. In some examples, computer system 600 may be used to implement the record topic prediction system within a distributed environment, and various servers and computer systems described above. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative examples of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 604 controls the operation of computer system 600 and may include one or more processors, application specific integrated circuits (ASICs), or field programmable gate arrays (FPGAs). The processors may include be single core or multicore processors. The processing resources of computer system 600 may be organized into one or more processing units 632, 634, etc. A processing unit may include one or more processors, one or more cores from the same or different processors, a combination of cores and processors, or other combinations of cores and processors. In some examples, processing subsystem 604 may include one or more special purpose co-processors such as graphics processors, digital signal processors (DSPs), or the like. In some examples, some or all of the processing units of processing subsystem may be implemented using customized circuits, such as application specific integrated circuits (ASICs), or field programmable gate arrays (FPGAs).

In some examples, the processing units in processing subsystem 604 may execute instructions stored in system memory 610 or on computer-readable storage media 622. In various examples, the processing units may execute a variety of programs or code instructions and may maintain multiple concurrently executing programs or processes. At any given time, some or all of the program code to be executed may be resident in system memory 610 and/or on computer-readable storage media 622 including potentially on one or more storage devices. Through suitable programming, processing subsystem 604 may provide various functionalities described above. In instances where computer system 600 is executing one or more virtual machines, one or more processing units may be allocated to each virtual machine.

In certain examples, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some examples. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide authentication in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 622 may store programming and data constructs that provide the functionality of some examples. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, DVD, a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 618 may also include a computer-readable storage media reader 620 that may further be connected to computer-readable storage media 622. Reader 620 may receive and be configured to read data from a memory device such as a disk, a flash drive, etc.

In certain examples, computer system 600 may support virtualization technologies, including but not limited to virtualization of processing and memory resources. For example, computer system 600 may provide support for executing one or more virtual machines. In certain examples, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices.

Communication subsystem 624 may support both wired and/or wireless communication protocols. In certain examples, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 602.XX family standards, or other mobile communication technologies, or any combination thereof), global positioning system (GPS) receiver components, and/or other components. In some examples, communications subsystem 624 may provide wired network connectivity (e.g., Ethernet) in addition to or instead of a wireless interface.

Communication subsystem 624 may receive and transmit data in various forms. In some examples, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 624 may be configured to receive data in the form of continuous data streams, which may include event streams 628 of real-time events and/or event updates 630, which may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, it should be appreciated there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
generating a dataset using a plurality of topics associated with a plurality of historical records, respectively, the dataset comprising pairs of data that are formed based on the plurality of topics, each of the pairs of data comprising an antecedent topic associated with a historical record corresponding to a preceding event and a consequent topic associated with a historical record corresponding to an event that occurred after the preceding event, the antecedent topic and the consequent topic forming a transitive relation for each of the pairs of data, wherein the plurality of historical records are associated with a plurality of user identifiers of different users;
inputting, into a machine learning (ML) model, the pairs of data and an input topic, among the plurality of topics, which is associated with a record of a user, the record of the user corresponding to a first event and being associated with a user identifier for the user;
generating, by the ML model, one or more predictions of one or more next record topics for a next record corresponding to the user identifier, based on consequent topics included in the pairs of data that include an antecedent topic corresponding to the input topic, wherein the next record corresponds to a second event; and
outputting the one or more predictions,
wherein the antecedent topic and the consequent topic are included in the plurality of topics.

2. The computer-implemented method of claim 1, wherein the generating the dataset further comprises:
obtaining historical reports for the plurality of user identifiers, respectively, each respective historical report including topics associated with a respective historical record for one of the plurality of user identifiers, the topics being arranged in a sequence based on a timeline, wherein the topics are included in the plurality of topics, and
forming each of the pairs of data to include a first topic of the topics that is associated with a first time point on the timeline and a second topic of the topics that is associated with a second time point on the timeline that is later in time than the first time point, as the antecedent topic and the consequent topic, respectively.

3. The computer-implemented method of claim 1, wherein the generating the dataset further comprises:
calculating a support value for each of the pairs of data, based on a total number of the plurality of historical records and a first number of the pairs of data that include a same first topic and a same second topic;
comparing the support value to a first predetermined threshold value; and
performing first filtering on the pairs of data by removing the pairs of data whose support value is smaller than or equal to the first predetermined threshold value, and outputting the pairs of data whose support values are greater than the first predetermined threshold value,
wherein the same first topic corresponds to the antecedent topic or the consequent topic, and the same second topic corresponds to the antecedent topic or the consequent topic.

4. The computer-implemented method of claim 3, wherein the generating the dataset further comprises:
calculating a confidence value for each of the pairs of data remaining subsequent to the first filtering, based on a second number of the pairs of data that include a same antecedent topic followed by a same consequent topic, and a third number of historical records among the plurality of historical records that include the same antecedent topic;
comparing the confidence value to a second predetermined threshold value;
performing second filtering on the pairs of data remaining subsequent to the first filtering, by removing the pairs of data whose confidence value is smaller than or equal to the second predetermined threshold value, and outputting filtered pairs of data having the confidence value greater than the second predetermined threshold value; and
calculating a lift value for each of the filtered pairs of data based on the confidence value associated with each of the filtered pairs of data and a fourth number of historical records among the plurality of historical records that include the same consequent topic.

5. The computer-implemented method of claim 4, wherein the inputting the filtered pairs of data further comprises inputting, into the ML model, the confidence value and the lift value that correspond to each of the filtered pairs of data, and
the generating the one or more predictions further comprises:
generating the one or more predictions based on the input topic and one or more consequent topics included in one or more pairs of data among the filtered pairs of data that include the antecedent topic corresponding to the input topic.

6. The computer-implemented method of claim 5, wherein the one or more pairs of data are included in a plurality of pairs of data, and
the generating the one or more predictions further comprises:
ordering the plurality of pairs of data in an order of decreasing confidence values,
identifying, as a first result group, first pairs of data among the plurality of pairs of data that have greatest confidence values, wherein a number of the first pairs of data is defined to be greater than 1 and smaller than a predetermined first number,
identifying, as a second result group, second pairs of data from the first result group that have greatest lift values, wherein a number of the second pairs of data is defined to be not smaller than 1 and smaller than the predetermined first number, and
generating the one or more predictions based on the second pairs of data.

7. The computer-implemented method of claim 1, further comprising:
based on the one or more predictions of the one or more next record topics, outputting a message for the user.

8. The computer-implemented method of claim 1, wherein the user is not one of the different users or is one of the different users.

9. A system comprising:
one or more data processors; and
one or more non-transitory computer-readable media storing instructions that, when executed by the one or more data processors, cause the one or more data processors to perform a method including:
generating a dataset using a plurality of topics associated with a plurality of historical records, respectively, the dataset comprising pairs of data that are formed based on the plurality of topics, each of the pairs of data comprising an antecedent topic associated with a historical record corresponding to a preceding event and a consequent topic associated with a historical record corresponding to an event that occurred after the preceding event, the antecedent topic and the consequent topic forming a transitive relation for each of the pairs of data, wherein the plurality of historical records are associated with a plurality of user identifiers of different users;
inputting, into a machine learning (ML) model, the pairs of data and an input topic, among the plurality of topics, which is associated with a record of a user, the record of the user corresponding to a first event and being associated with a user identifier for the user;
generating, by the ML model, one or more predictions of one or more next record topics for a next record corresponding to the user identifier, based on consequent topics included in the pairs of data that include an antecedent topic corresponding to the input topic, wherein the next record corresponds to a second event; and
outputting the one or more predictions,
wherein the antecedent topic and the consequent topic are included in the plurality of topics.

10. The system of claim 9, wherein the generating the dataset further includes:
obtaining historical reports for the plurality of user identifiers, respectively, each respective historical report including topics associated with a respective historical record for one of the plurality of user identifiers, the topics being arranged in a sequence based on a timeline, wherein the topics are included in the plurality of topics, and
forming each of the pairs of data to include a first topic of the topics that is associated with a first time point on the timeline and a second topic of the topics that is associated with a second time point on the timeline that is later in time than the first time point, as the antecedent topic and the consequent topic, respectively.

11. The system of claim 9, wherein the generating the dataset further includes:
calculating a support value for each of the pairs of data, based on a total number of the plurality of historical records and a first number of the pairs of data that include a same first topic and a same second topic;
comparing the support value to a first predetermined threshold value; and
performing first filtering on the pairs of data by removing the pairs of data whose support value is smaller than or equal to the first predetermined threshold value, and outputting the pairs of data whose support values are greater than the first predetermined threshold value,
wherein the same first topic corresponds to the antecedent topic or the consequent topic, and the same second topic corresponds to the antecedent topic or the consequent topic.

12. The system of claim 11, wherein the generating the dataset further includes:
calculating a confidence value for each of the pairs of data remaining subsequent to the first filtering, based on a second number of the pairs of data that include a same antecedent topic followed by a same consequent topic, and a third number of historical records among the plurality of historical records that include the same antecedent topic;
comparing the confidence value to a second predetermined threshold value;
performing second filtering on the pairs of data remaining subsequent to the first filtering, by removing the pairs of data whose confidence value is smaller than or equal to the second predetermined threshold value, and outputting filtered pairs of data having the confidence value greater than the second predetermined threshold value; and
calculating a lift value for each of the filtered pairs of data based on the confidence value associated with each of the filtered pairs of data and a fourth number of historical records among the plurality of historical records that include the same consequent topic.

13. The system of claim 12, wherein the inputting the filtered pairs of data further includes inputting, into the ML model, the confidence value and the lift value that correspond to each of the filtered pairs of data, and
the generating the one or more predictions further includes:
generating the one or more predictions based on the input topic and one or more consequent topics included in one or more pairs of data among the filtered pairs of data that include the antecedent topic corresponding to the input topic.

14. The system of claim 13, wherein the one or more pairs of data are included in a plurality of pairs of data, and
the generating the one or more predictions further includes:
ordering the plurality of pairs of data in an order of decreasing confidence values,
identifying, as a first result group, first pairs of data among the plurality of pairs of data that have greatest confidence values, wherein a number of the first pairs of data is defined to be greater than 1 and smaller than a predetermined first number,
identifying, as a second result group, second pairs of data from the first result group that have greatest lift values, wherein a number of the second pairs of data is defined to be not smaller than 1 and smaller than the predetermined first number, and
generating the one or more predictions based on the second pairs of data.

15. A computer-program product tangibly embodied in one or more non-transitory machine-readable media including instructions configured to cause one or more data processors to perform a method including:
generating a dataset using a plurality of topics associated with a plurality of historical records, respectively, the dataset comprising pairs of data that are formed based on the plurality of topics, each of the pairs of data comprising an antecedent topic associated with a historical record corresponding to a preceding event and a consequent topic associated with a historical record corresponding to an event that occurred after the preceding event, the antecedent topic and the consequent topic forming a transitive relation for each of the pairs of data, wherein the plurality of historical records are associated with a plurality of user identifiers of different users;
inputting, into a machine learning (ML) model, the pairs of data and an input topic, among the plurality of topics, which is associated with a record of a user, the record of the user corresponding to a first event and being associated with a user identifier for the user;
generating, by the ML model, one or more predictions of one or more next record topics for a next record corresponding to the user identifier, based on consequent topics included in the pairs of data that include an antecedent topic corresponding to the input topic, wherein the next record corresponds to a second event; and
outputting the one or more predictions,
wherein the antecedent topic and the consequent topic are included in the plurality of topics.

16. The computer-program product of claim 15, wherein the generating the dataset further includes:
obtaining historical reports for the plurality of user identifiers, respectively, each respective historical report including topics associated with a respective historical record for one of the plurality of user identifiers, the topics being arranged in a sequence based on a timeline, wherein the topics are included in the plurality of topics, and
forming each of the pairs of data to include a first topic of the topics that is associated with a first time point on the timeline and a second topic of the topics that is associated with a second time point on the timeline that is later in time than the first time point, as the antecedent topic and the consequent topic, respectively.

17. The computer-program product of claim 15, wherein the generating the dataset further includes:
calculating a support value for each of the pairs of data, based on a total number of the plurality of historical records and a first number of the pairs of data that include a same first topic and a same second topic;
comparing the support value to a first predetermined threshold value; and
performing first filtering on the pairs of data by removing the pairs of data whose support value is smaller than or equal to the first predetermined threshold value, and outputting the pairs of data whose support values are greater than the first predetermined threshold value,
wherein the same first topic corresponds to the antecedent topic or the consequent topic, and the same second topic corresponds to the antecedent topic or the consequent topic.

18. The computer-program product of claim 17, wherein the generating the dataset further includes:
calculating a confidence value for each of the pairs of data remaining subsequent to the first filtering, based on a second number of the pairs of data that include a same antecedent topic followed by a same consequent topic, and a third number of historical records among the plurality of historical records that include the same antecedent topic;
comparing the confidence value to a second predetermined threshold value;
performing second filtering on the pairs of data remaining subsequent to the first filtering, by removing the pairs of data whose confidence value is smaller than or equal to the second predetermined threshold value, and outputting filtered pairs of data having the confidence value greater than the second predetermined threshold value; and
calculating a lift value for each of the filtered pairs of data based on the confidence value associated with each of the filtered pairs of data and a fourth number of historical records among the plurality of historical records that include the same consequent topic.

19. The computer-program product of claim 18, wherein the inputting the filtered pairs of data further includes inputting, into the ML model, the confidence value and the lift value that correspond to each of the filtered pairs of data, and
the generating the one or more predictions further includes:
generating the one or more predictions based on the input topic and one or more consequent topics included in one or more pairs of data among the filtered pairs of data that include the antecedent topic corresponding to the input topic.

20. The computer-program product of claim 19, wherein the one or more pairs of data are included in a plurality of pairs of data, and
the generating the one or more predictions further includes:
ordering the plurality of pairs of data in an order of decreasing confidence values,
identifying, as a first result group, first pairs of data among the plurality of pairs of data that have greatest confidence values, wherein a number of the first pairs of data is defined to be greater than 1 and smaller than a predetermined first number,
identifying, as a second result group, second pairs of data from the first result group that have greatest lift values, wherein a number of the second pairs of data is defined to be not smaller than 1 and smaller than the predetermined first number, and
generating the one or more predictions based on the second pairs of data.
